(19) United States
(12) Patent Application Publication
(10) Pub. No.: US 2006/0216568 A1
(43) Pub. Date: Sep. 28, 2006

(54) Fuel cell unit, fuel cell unit assembly and electronic equipment

(76) Inventors: Ryuji Kohno, Kasumigaura (JP); Makoto Kitano, Tsuchiura (JP); Hayami Toba, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/356,098

(22) Filed: Feb. 17, 2006

(30) Foreign Application Priority Data
Mar. 25, 2005 (JP) 2005-088107

(51) Int. Cl. H01M 8/02; H01M 8/10; H01M 8/24

(52) U.S. Cl. 429/34; 429/37; 429/32

(57) ABSTRACT

For providing a fuel cell unit and a fuel cell unit assembly, wherein membrane electrode assembly and current collector plates are closely contact with each other, so that a liquid fuel hardly leaks out therefom, and further an electronic apparatus equipped with those therein, a DMFC unit U1 for generating electricity through supply of methanol solution therein comprises a MEA 11, a pair of current collector plates 12 and 13 for the MEA, a fuel tank 20 having a fuel chamber 20a where the methanol solution is stored therein, and a holding means 40 for holding the current collector plates 12 and 13 within an area where the MEA 11 is disposed.

### BACKGROUND OF THE INVENTION

The present invention relates to a fuel cell unit, a fuel cell unit assembly and also electronic equipment equipped with those.

In recent years, developments are made vigorously upon fuel cells, such as, a Direct Methanol Fuel Cell (DMFC), etc., as an electric power supply for a portable terminal or the like. The fuel cell has a Membrane Electrode Assembly (MEA), being constructed with an anode (or a fuel electrode) and a cathode (or an air electrode), as well as, an electrolyte film or membrane being put between them. And for the purpose of taking out electric energy from it, effectively, the MEA is held between a pair of current collectors.

For example, as is shown in the following Patent Document 1, in case of a fuel cell stack laminating or piling up the MEAs therein, there are provided joint plates on both outsides of the fuel cell stack, respectively, and those joint plates are connected by means of joint bolts at every four corners thereof, thereby putting the MEAs between the pair of current collectors.

Patent Document 1: Japanese Patent Laying-Open No. Hei 9-92323 (1997) (in particular, columns 0014-0017, FIG. 1)

However, when the joint plates are connected at the four corners thereof, as is described in the Patent Document 1, holding force (or, a clamping load) acts at the maximum, in the vicinities of those four corners of the pair of current collector plates 103 and 104, putting the MEA 102 therebetween, and then it comes down to be small as it goes away from the vicinities of those four corners. Thus, although the MEA is put between the collector plates 103 and 104, but the holding force applied thereon has such distribution; i.e., coming down small at a middle position on each side of the current collector plates 103 and 104, and also at a central position of the MEA 102. Then, if the holding force comes down to be less than a certain value at the central position of the MEA 102, gaps are defined between the MEA 102 and the current collector plates 103 and 104, through which a methanol aqueous solution (i.e., a liquid fuel) comes out; thereby, sometimes it resulting into reduction of an output of the fuel cell.

Then, according to the present invention, an object thereof is to provide a fuel cell unit and a fuel cell unit assembly, wherein the membrane electrode assembly and the current collector plates closely adhere to each other, so that the liquid fuel hardly leaks out therethrough, and further electronic equipment including such therein.

### BRIEF SUMMARY OF THE INVENTION

For accomplishing the object mentioned above, according to the present invention, there is 1. A fuel cell unit for generating electricity through supply of a liquid fuel therein, comprising: a membrane electrode assembly; a pair of current collector plates for said membrane electrode assembly; a fuel tank having a liquid-fuel storage space for storing the liquid fuel therein; and a holding means for holding said current collector plates therebetween, within an area for disposing said membrane electrode assembly.

Herein, “within an area for disposing the membrane electrode assembly” means an inside of the outer edge of the membrane electrode assembly. Accordingly, the position being held by the holding means may be anywhere as far as within inside the outer edge of the membrane electrode assembly, for example, a portion corresponding to the through-hole of the membrane electrode assembly, as is described in a first embodiment, which will be mentioned later.

Or, in case of disposing the plural number of the membrane electrode assemblies on a surface in direction thereof, it may be within an inside of the outer edge of the plural number of membrane electrode assemblies disposed on the surface in direction thereof.

With such the fuel cell unit, while putting the membrane electrode assembly between a pair of current collector plates, by means of the holding means, the current collector plates are held therebetween, within an area where the membrane electrode assembly is disposed, so that the membrane electrode assembly in closely contact with each of the current collector plates, preferably, at a central position and so on, of the membrane electrode assembly. With this, the liquid fuel hardly leaks out through the gap between the membrane electrode assembly and the current collector plates, and at the same time, it is also possible to take out electric energy therefrom, upon basis of the potential difference generated within the membrane electrode assembly.

According to the present invention, it is possible to bring the membrane electrode assembly and the current collector plates closely in contact with each other, preferably, and thereby providing a fuel cell unit and a fuel cell assembly of hardly leaking out the liquid fuel therefrom, and an electronic apparatus being equipped with those therein.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a perspective view for showing the conception of the present invention, diagrammatically;

FIG. 2 is a perspective view of a DMFC unit, according to a first embodiment;

FIG. 3 is X-X cross-section view of the DMFC unit shown in FIG. 2;

FIG. 4 is an exploded perspective view of the DMFC unit shown in FIG. 2;

FIG. 5 is a cross-section view of a DMFC unit, according to a second embodiment;

FIG. 6 is a cross-section view of a DMFC unit, according to a third embodiment;

FIG. 7 is a cross-section view of a DMFC unit, according to a fourth embodiment;

FIG. 8 is a cross-section view of a DMFC unit, according to a fifth embodiment;

FIG. 9 is a plane cross-section view of the DMFC unit, according to the fifth embodiment;

FIG. 10 is a cross-section view of a DMFC unit, according to a sixth embodiment;

FIG. 11 is a cross-section view of a DMFC pack, according to a seventh embodiment;

FIG. 12 is a partial exploded perspective view of a DMFC unit, according to an eighth embodiment;

FIG. 13 is a cross-section view of a DMFC unit, according to a ninth embodiment;

FIG. 14 is a perspective view of a DMFC unit, according to other embodiment; and

FIG. 15 is a perspective view for showing the conventional MEA and current collector plates thereof, diagrammatically.

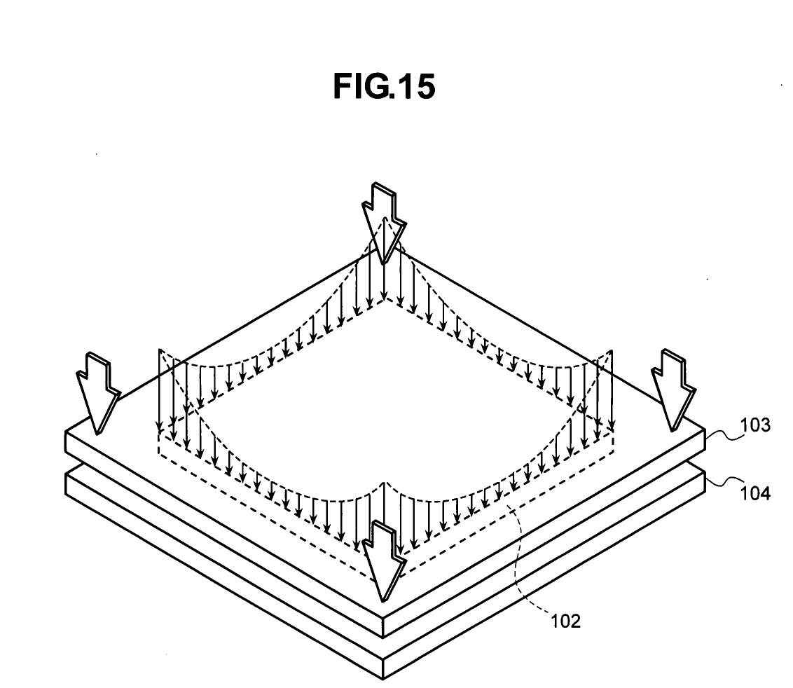

### DETAILED DESCRIPTION OF THE INVENTION

<<Concept of the Present Invention>>

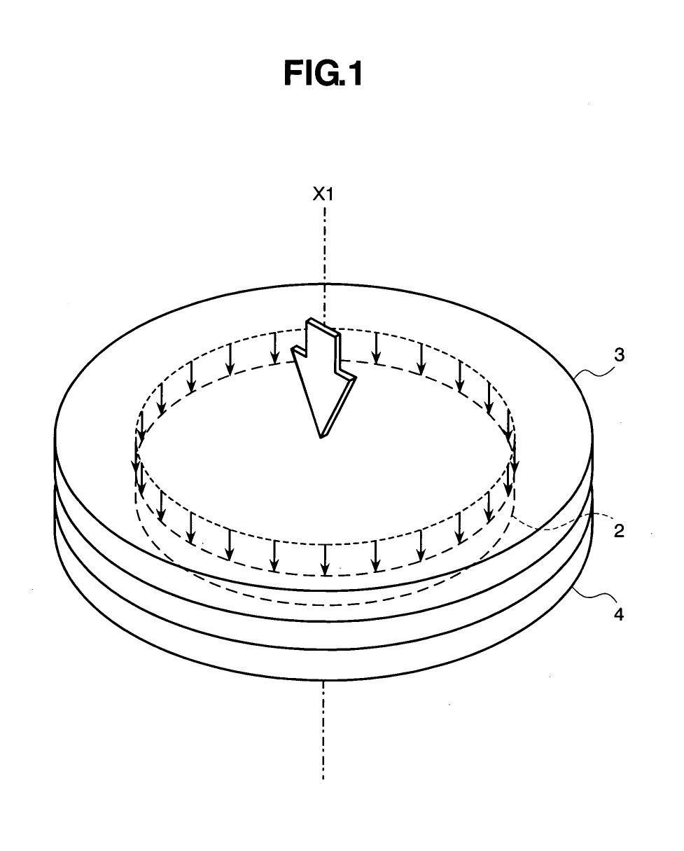

First of all, before explanation of the embodiments thereof, explanation will be made about the conception of the present invention, by referring to FIG. 1. FIG. 1 shows the perspective view of the concept of the present invention, diagrammatically.

As is shown in FIG. 1, according to the present invention, it is characterized that a MEA 2 is held at the maximum folding force within an area where the MEA 2 is disposed, when being held by a pair of current collector palates 3 and 4. However, this FIG. 1 shows a case where disk-like current collector plates 3 and 4 are disposed on a line same to the central axial line of the MEA 2, each of which is a little bit larger than the MEA 2, on both of disk-like surfaces of the MEA 2, so that the current collector plates 3 and 4 are held at the central position of the disposing area of the MEA 2 (e.g., at the position passing through the center of the MEA 2).

Hereinafter, explanation will be made on various embodiments applying the concept of the present invention therein, by referring to the drawings, appropriately. However, in the explanations made on the various embodiments, the same reference numerals are given relating to the constituent elements being same or similar thereto, so as to eliminate duplicate explanation thereof.

### FIRST EMBODIMENT

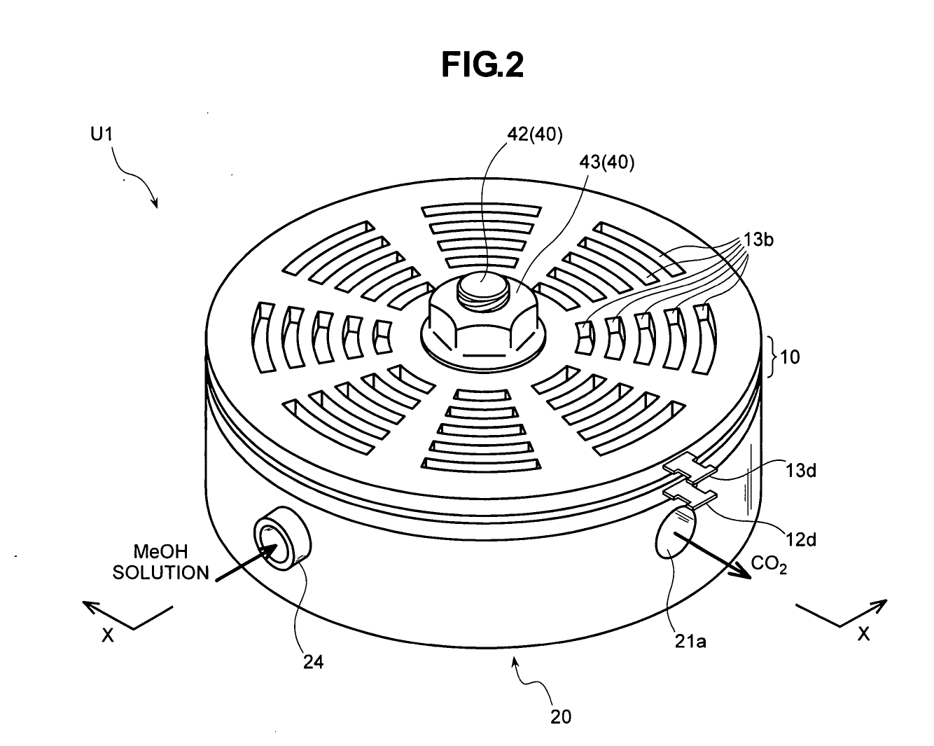

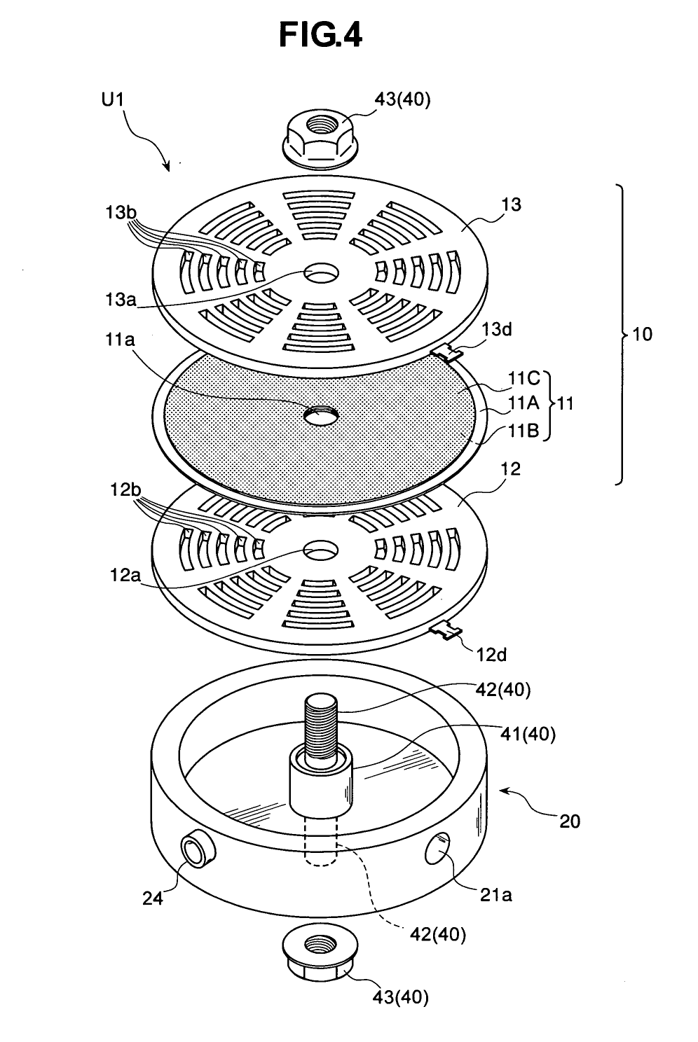

Explanation will be made about a DMFC unit (i.e., the fuel cell unit), according to a first embodiment, by referring to FIGS. 2 through 4. In the drawings to be referred, in particular, FIG. 2 is a perspective view of the DMFC unit according to the first embodiment. FIG. 2 is the X-X cross-section view of the DMFC unit shown in FIG. 2. And, FIG. 4 is the exploded perspective view of the DMFC unit shown in FIG. 2.

<<Structures of DMFC Unit>>

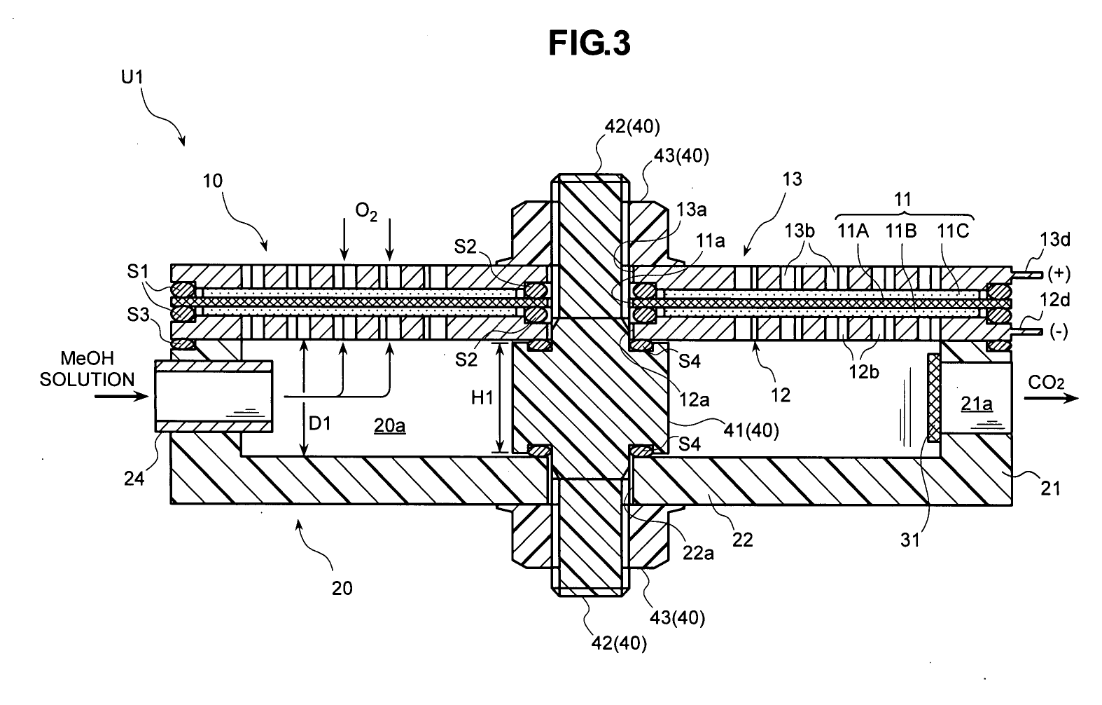

As is shown in FIG. 2, the DMFC unit U1 according to the first embodiment is about column-like in the outer shape thereof. The DMFC unit U1 is the Direct Methanol Fuel Cell (DMFC), wherein electric power is generated through supplying methanol aqueous solution (e.g., the liquid fuel) onto an anode 11B while supplying oxygen onto a cathode 11C. Such the DMFC unit U1 may be used as an outer electric power supply or source for the portable terminals, such as, a personal computer, for example. And, as is shown in FIGS. 3 and 4, in addition to FIG. 2, the DMFC unit U1 comprises a MEA module 10, a fuel tank 20 and a holding means 40, mainly.

<MEA Module>

The MEA module 10, being also disk-like in the outer shape thereof, comprises a MEA 11, a pair of current collector plates (e.g., anode collector plates) and other current collectors (e.g., cathode collector plates), mainly, wherein they are made in the form of a module.

[MEA]

The MEA 11 has a thin-type disk-like form in the outer shape thereof. Accordingly, “disposing area of MEA” according to the first embodiment defines a circle, and an outer periphery thereof is circular. The MEA 11 has an opening 11a penetrating through (i.e., a through hole) on a central axial line thereof (see FIG. 4). And, into the through hole 11a passed through a screw rod 42, which will be mentioned later.

Such the MEA 11 comprises a disk-like electrolyte film or membrane 11A, a disk-like anode 11B (e.g., the fuel electrode), and a disk-like cathode (e.g., the air electrode). And then, the MEA 11 is built up with the anode 11B and the cathode 11C, holding the electrolyte membrane 11A between them.

Further, the electrolyte membrane 11A, the anode 11B and the cathode 11C are disposed on the same central axial line thereof. Each of the electrolyte membrane 11A, the anode 11B and the cathode 11C has a through hole on the central axial line, respectively, and piling-up of those defines the through hole 11a. Also, ring-like sealing members S1 and S2 are provided along an outer periphery of the anode 11B and an inner periphery of the anode 11B, respectively, so as to enhance sealing property or capacity of preventing the methanol aqueous solution (hereinafter, only “methanol solution”) from leaking into an outside thereof. In the similar manner, sealing other members S1 and S2 are also provided along an outer periphery and an inner periphery of the anode 11C, respectively.

The electrolyte membrane 11A is a film for transmitting proton (H⁺) generated within the anode 11B to the cathode 11C, selectively. As such the electrolyte membrane 11A, the following films may be applied, appropriately and selectively, being made from a film of perfluorocarbon sulfonic acid (PFS) group, or a copolymerized film of derivative of trifluorostyrene, a film of polybenzimidazole impregnated with phosphoric acid, a film of aromatic polyetherkethone sulfonic acid, PSSA-PVA (polystyrene sulfonic acid ethylene vinyl alcohol polymer, etc. Among of those, it is preferable to select a film made of an ion exchange resin having a radical of carbon sulfonic acid including fluorine therein, and in more details thereof, a “nafyon®” made by Dupont Co. of U.S.A. can be listed, for example.

The anode 11B is an electrode, being called by a gas diffusion election, too, and it produces electrons and protons through oxidization of ethanol, being the fuel thereof. To be such the anode 11B may be applied one, carrying particles of platinum (Pt) or iron (Fe), or particles of an alloy or an oxide thereof, etc., including platinum and a transition metal, such as, nickel (Ni), cobalt (Co) or ruthenium (Ru) or the like, on a side surface of a conductive member, such as, a carbon paper, a carbon cloth, etc., facing to the electrolyte membrane 11A, as a catalyst thereof.

The cathode 11C is an electrode, also being called by a gas diffusion election, too, and it makes reaction between the electrons transmitting from the anode 11B through an outer circuit and the protons reaching to the cathode 11C through moving within the electrolyte membrane 11A after being produced in the anode 11B, thereby producing water. To be such the anode 11C also may be applied that, carrying a catalyst of platinum or the like, on a side surface of a carbon paper, facing to the electrolyte membrane 11A, in the similar manner to the anode 11B.

[Current Collector Plates]

The current collector plates 12 and 13 are those for taking out electric energy therefrom, effectively, upon the basis of potential difference generated within the MEA 11 (see FIG. 4), and they are made of a material having conductivity and corrosion resistance (for example, a metal, such as, titanium). Also, each of the current collector plates 12 and 13 has a predetermined thickness (for example, 0.05-0.2 mm), and also has a predetermined stiffness or rigidity. Further, each of the current collector plates 12 and 13 has an outer shape of being disk-like, and has a through hole 12a or 13a on the central axial line thereof. And, into those through hole 12a or 13a is passed through the screw rod 42, which will be mentioned later.

The current collector plate 12 is disposed on a side facing to the anode 11B of the MEA 11, while the current collector plate 13 on a side facing to the anode 11C of the MEA 11. And, with an aid of the holding member 40, the current collector plates 12 and 13 put or sandwich the MEA 11, wherein the current collector plate 12 adheres closely onto the anode 11B and the current collector plate 13 onto the cathode 11C.

In the current collector plate 12 are formed of fuel flow openings 12b in plural number thereof into a circumferential direction and radial directions thereof (see FIG. 4). And the methanol solution within the fuel tank 20 is supplied to the anode 11B through the fuel flow openings 12b. Also, onto the current collector plate 12 is attached a minus terminal 12d as an output terminal. Further, portions of the surfaces of the current collector plate 12, where it does not contact with the anode 11B, are coated with an insulating film or coating (not shown in the figure) of resin, thereby to protect it from unnecessary short-circuiting thereof.

In the current collector plate 13 are also formed of airflow openings 13b in plural number thereof into a circumferential direction and radial directions thereof (see FIG. 4). And the air outside the DMFC unit 1, including oxygen therein, is supplied to the cathode 11C through the airflow openings 13b. Further, portions of the surfaces of the current collector plate 13, where it does not contact with the cathode 11C, are coated with an insulating film or coating (not shown in the figure) of resin, thereby to protect it from unnecessary short-circuiting thereof.

<Fuel Tank>

The fuel tank 20, being in a thin cylindrical shape having a bottom, has a peripheral or surrounding wall 21 and a bottom wall 22 (see FIGS. 3 and 4), and defines a fuel chamber 20a (i.e., a liquid-fuel storing space) for storing the methanol solution, temporally, within an inside thereof. And, the fuel tank 20 is disposed on a side of the MEA module 10 facing to the anode 11B (e.g., the lower side in FIG. 3). Thus, the fuel tank 20 is opened at side facing to the MEA module 10 (e.g., the upper side in FIG. 3).

Between the fuel tank 20 and the MEA module 10 is provided a ring-like sealing member S3. With this, the methanol solution is prevented from leaking outside through gaps between the fuel tank 20 and the MEA module 10.

On the surrounding wall 21 of the fuel tank 20 are formed a connecting hole 21a, connecting between the fuel chamber 20a and an outside. And, a carbon-dioxide permeable film or membrane 31 is fixedly attached, thereby covering over the connecting hole 21a from a side of the fuel chamber 20a. As such the carbon-dioxide permeable film or membrane 31 may be applied a porous film made of a material of polytetrafluorethylene (for example, NW laminate film made by Japan Goa-Tech Ltd.), etc.

Accordingly, when the DMFC unit U1 generates electricity, carbon dioxide generated in the anode 11B can pass through the carbon-dioxide permeable membrane 31, so as to be discharged into an outside of the DMFC unit U1. With this, no carbon dioxide remains within the fuel chamber 20a, and the methanol solution can be supplied to the anode 11B; therefore, the DMFC unit U1 can generate electricity, continuously, without lowering an output thereof.

On the bottom wall 22 is form a a through-hole 22a along the central axial line thereof. And into the through-hole is passed through the screw rod 42, which will be mentioned later.

Also, onto the fuel tank 20 is fixed a fuel intake pipe 24. This fuel intake pipe 24 is a portion to be connected with the fuel cartridge (not shown in the figure), enclosing the methanol solution therein. And, the methanol solution can be supplied into the fuel chamber 20a from the fuel cartridge via the fuel intake pipe 24.

<Holding Means>

The holding means 40 is provided for holding the MEA module 10, putting it therebetween. A position where the holding means 40 holds between the MEA module 10 is determined to be on the central axial line of the MEA 11, being within an area where the EEA 11 is disposed. Such the holding means 40 comprises a spacer 41 (i.e., an axial member), which is disposed within the fuel chamber 20a, the screw rod 42 (i.e., the axial member), which is fixed on an upper surface of the spacer 41, the screw rod 42 (i.e., the axial member), which is fixed on a lower surface of the spacer 41, and nuts 43 and 43 (i.e., screwing members), each of which is screwed into thread groove of the screw rod 42, in the structures thereof.

The spacer 41, approximately cylindrical in the outer configuration thereof, keeps the distance between the MEA module 10 and the bottom wall 22 at a predetermined length when each the nut 43 is screwed onto the screw rod 42, respectively; i.e., being a member for maintaining the space of the fuel chamber 20a in the height thereof. The height “H1” of the spacer 41 is determined in the degree thereof, so that it is a little bit shorter than the depth “D1” of the fuel chamber 20a. Up and down of the spacer are provided ring-like sealing members S4 and S4, respectively, thereby to prevent the methanol solution from leaking outside through gaps between the spacer 41 and the current collector plate 12 and between the spacer 41 and the bottom wall 22.

The screw rod 42 fixed on the upper surface of the spacer 41 passes through the through-holes 12a, 11a, and 13a projects on an upper surface side of the current collector plate 13. Herein, as was mentioned above, since the through-hole 11a is formed along the central axial line of the MEA 11, the screw rod 42 is disposed to direct into a normal line, passing through the center of an area where the MEA 11 is disposed.

On the other hand, the screw rod 42 fixed on the lower surface of the spacer 41 passes through the through-hole 22a, and it projects into a lower side of the bottom wall 22.

Accordingly, in an upper side of the DMFC unit U1, screwing up of the nut 43 onto the screw rod 42 to a predetermined degree brings the spacer 41 and the nut 43 to hold the MEA module 10, putting it between them. When the MEA module 10 is put between them in this manner, then the current collector plates 12 and 13, each having the stiffness or rigidity, come to hold the MEA 11 between them. Also, holding it between them in this manner brings the sealing members S1, S1, S2, S2 and S4 to be crushed or struck, so as to obtain preferable sealing therebetween.

Herein, since the rod screw 42 is disposed into direction of the normal line passing through the center of the area where the MEA 11 is disposed, as was mentioned above, the holding forces holding the MEA 11 between the current collector plates 12 and 13 come to be small in the distribution thereof a little bit, directing into the radial direction outwards, however they are equal in the peripheral direction thereof (see FIG. 1). With this, great increase or enhancement can be achieved in adherences between the anode 11B and the current collector plate 12 on the side facing thereto, and between the cathode 11C and the current collector plate 13 on the side opposite thereto, comparing to the conventional arts. Also, the MEA 11 and the current collector plates 12 and 13 adhere to each other, preferably, on a side of the MEA 11 facing to the center thereof, thereby preventing the methanol solution from leaking outside therethrough.

While, on the lower side of the DMFC unit U1, screwing up of the nut 43 onto the screw rod 42 to a predetermined degree brings the spacer 41 and the nut 43 to hold the bottom wall 22 of the fuel tank 20, putting it between them, thereby be crushing or striking the sealing member S3. so as to obtain sealing therebetween.

Also, screwing up an upper-side nut 43 and a lower-side nut 43 together with brings the sealing member S3 to be crushed or struck, so as to obtain sealing therebetween.

<<Operation of DMFC Unit>>

Next, the operations of the DMFC unit U1 will be explained, by mainly referring to FIG. 3.

<DMFC Unit-Anode Side>

First, explanation will be given about the DMFC unit U1, in particular, on the side of the anode 11B thereof.

The methanol solution (for example, including methanol of 10 weight % in concentration thereof) is supplied into the fuel chamber 20a, from the fuel cartridge of an outside through the fuel intake pipe, to be stored within the fuel chamber 20a, temporally. Next, the methanol solution within the fuel chamber 20a is supplied to the anode 11B of the MEA 11 through the plural number of fuel flow openings 12b of the current collector plate 12.

On the anode 11B, to which the methanol solution is supplied, the methanol solution reacts on water, thereby producing proton (H⁺), carbon dioxide (CO₂) and electron (e⁻), under the existence of the catalyst, such as, platinum or the like being carried, as is shown by the following equation (1), depending on a demand of electric power from an electronic apparatus (for example, a note-type personal computer, etc.), which is connected to the output terminals (e.g., the minus terminal 12d and the plus terminal 13d) of the DMFC unit U1. Next, the proton (H⁺) moves towards the cathode 11C within the electrolyte film or membrane 11A, with driving force due to the concentration gradient thereof.
CH₃OH+H₂O→CO₂+6H⁺+6e⁻ (1)

Also, the carbon dioxide produced in the anode 11B is mixed into the methanol solution within the fuel chamber 20a, in the form of bubbles, passing from the anode 11B passing through the fuel flow openings 12b. Next, the bubbles of the carbon dioxide moves within the methanol solution, and passes through the carbon-dioxide permeable membrane 31; thereby being discharged quickly into an outside of the DMFC unit U1. Accordingly, the bubbles of carbon dioxide hardly remain in the methanol solution within the fuel chamber 20a, and the methanol solution can be supplied to the anode 11B, preferably.

<DMFC Unit-Cathode Side>

Next, explanation will be given about the DMFC unit U1, in particular, on a side of the cathode 11C.

Air containing oxygen therein is supplied to the cathode 11C of the MEA 11, passing through the plural number of airflow openings 13b of the current collector plate 13. On the cathode 11C, the oxygen reacts on the proton (H⁺) moving within the electrolyte membrane 11A and the electron (e⁻) via the outside electronic apparatus, thereby producing water, as is shown by the following equation (2).
O₂+4H⁺+4e⁻→2H₂O (2)

Due to continuous generation of such reactions upon the anode 11B and the cathode 11C, the DMFC unit U1 continues the generation of electricity.

Herein, as was mentioned above, within the DMFC unit U1 according to the first embodiment, the anode 11B and the current collector plate 12, and also the cathode 11C and the current collector plate 13 adhere to each other, respectively, and therefore it is possible to take out electric energy, effectively, upon basis of the potential difference generated within the MEA 11.

### SECOND EMBODIMENT

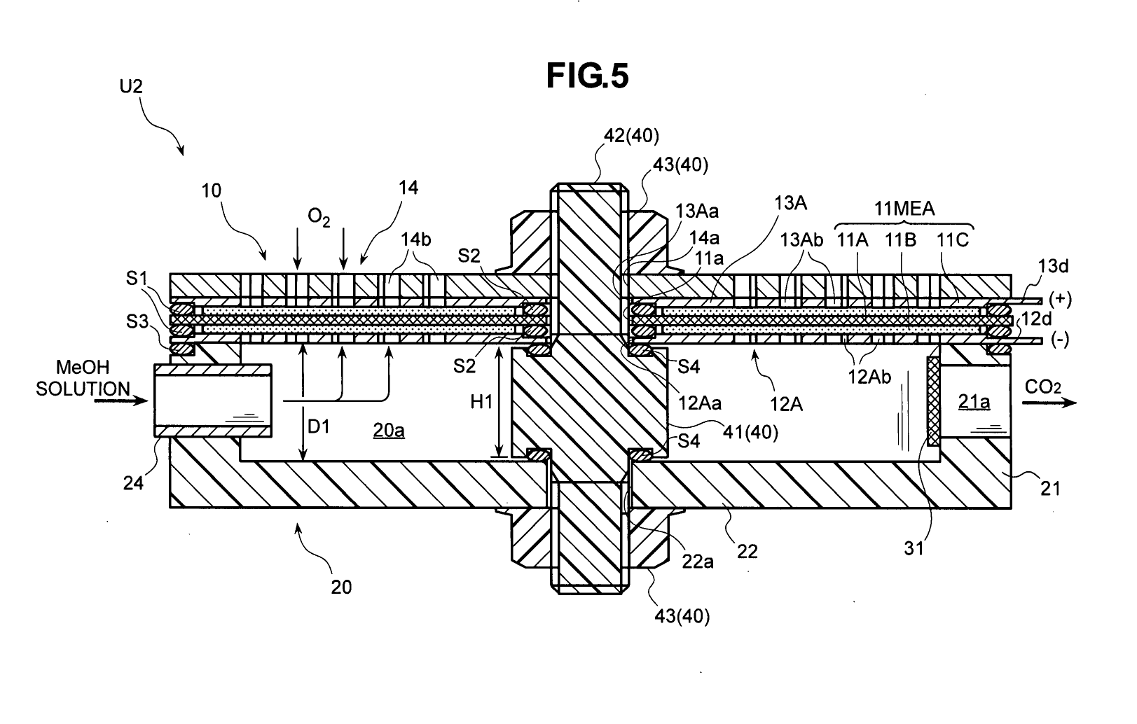

Next, explanation will be made about a DMFC unit according to a second embodiment, by referring to FIG. 5. This FIG. 5 is the cross-section view of the DMFC unit according to the second embodiment.

<<Structures of DMFC Unit>>

As is shown in FIG. 5, the DMFC unit U2 according to the second embodiment, comparing to the DMFC unit U1 (see FIG. 3) according to the first embodiment, comprises current collector plates 12A and 13A, and at the same time, a holding plate 14 on the upper side (i.e., outside) of the current collector plate 13A.

<Current Collector Plate>

Thickness of the current collector plate 12A or 13A is thinner than that of the current collector plates 12 or 13 according to the first embodiment (see FIG. 3), and therefore it lowers the stiffness or rigidity lower thereof. With this, the current collector plate 12A can follow very small concave/convex on the surface of the anode 11B, so as to closely contact or adhere onto the anode 11A, preferably. In the similar manner, the current collector plate 13A can also closely contact or adhere onto the current collector plate 11C, preferably.

Also, on the current collector plate 12A are formed a through-hole 12Aa and a fuel flow opening 12Ab. On the current collector plate 13A are formed a through-hole 123a and a fuel flow opening 13Ab.

<Holding Plate>

The holding plate 14 has an outer shape of being disk-like, and has a through hole 14a formed along the central axial line thereof. Into this through-hole is passed through the screw rod 42. Also, in the holding plate 14 are formed a plural number of airflow openings 14b corresponding to the airflow openings 13Aa of the current collector plate 13A, so that the air containing oxygen therein can be supplied to the cathode 11C via the airflow openings 13Aa.

Further, the holding plate 14 has a predetermined thickness (for example, 0.2-2.0 mm), and has a predetermined stiffness or rigidity. Such the holding plate 14 may be made of an alloy of stainless, aluminum, and magnesium, etc., which is treated with an insulating process at least on the surface thereof, or a resin material having property of corrosion-resistance, etc., for example.

Accordingly, even though the current collector plates 12A and 13A are lower in the stiffness or rigidity, comparing to that according to the first embodiment; however, since they are held from the upper side of the current collector plate 13A by means of the holding plate 14, therefore the current collector plate 12A and the anode 11B and the current collector plate 13A and the cathode 12B are preferably adhered to each other, respectively.

### THIRD EMBODIMENT

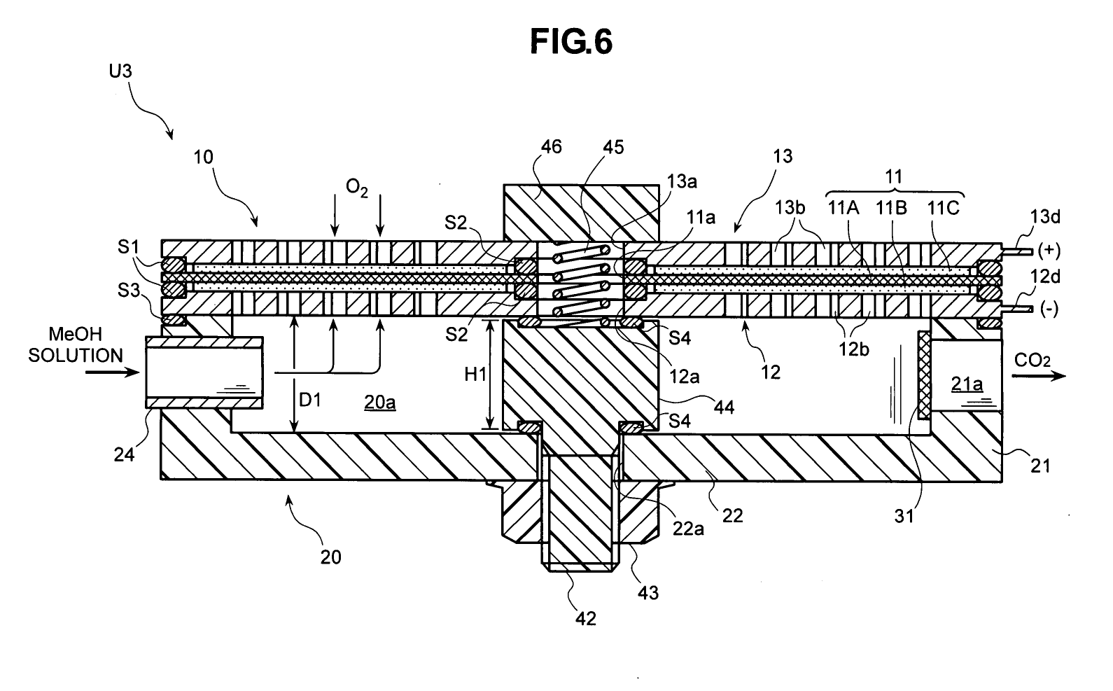

Next, explanation will be made about a DMFC unit according to a third embodiment, by referring to FIG. 6. This FIG. 6 is the cross-section view of the DMFC unit according to the third embodiment.

<<Structures of DMFC Unit>>

As is shown in FIG. 6, the DMFC unit U3 according to the third embodiment, comparing to the DMFC unit U1 (see FIG. 3) according to the first embodiment, is characterized by comprising a holding means, including a tension coil spring 45.

<Holding Means>

The holding means according to the third embodiment mainly comprises a spacer 44, a tension coil spring 45, and an end plate 46. The spacer 44 is disposed within the fuel chamber 20a, in the similar manner to the spacer 41 (see FIG. 3), on upper and lower surfaces of which are provided sealing members S4 and S4.

The tension coil spring 45 is loosely inserted into the through-holes 12a, 11a and 13a. The lower end of the tension coil spring 45 is fixed on the spacer 44, and the upper end thereof is fixed on the end plate 46. However, the end plate 46 is hooked on an upper surface of the current collector plate 13. And, due to tensile force (i.e., suppressing force) of the tension coil spring 45, the spacer 44 and the end plate 46 are pulled up, so that the MEA module 10 is held therebetween.

With such the DMFC unit U3, i.e., the structures of holding MEA module 10 with using the tensile force (i.e., suppressing force) of the tension coil spring 45, it is possible to lighten or reduce fluctuation in hooding force, due to changes of sizes in various parts upon basis of the circumstances of using the DMFC unit U3 (for example, temperature and/or humidity), by the function of the tension coil spring 45. Thus, it is possible to stop or reduce the fluctuation in the holding force applying onto the MEA module 10 upon basis of changes of the circumstances of using the DMFC unit U3.

### FOURTH EMBODIMENT

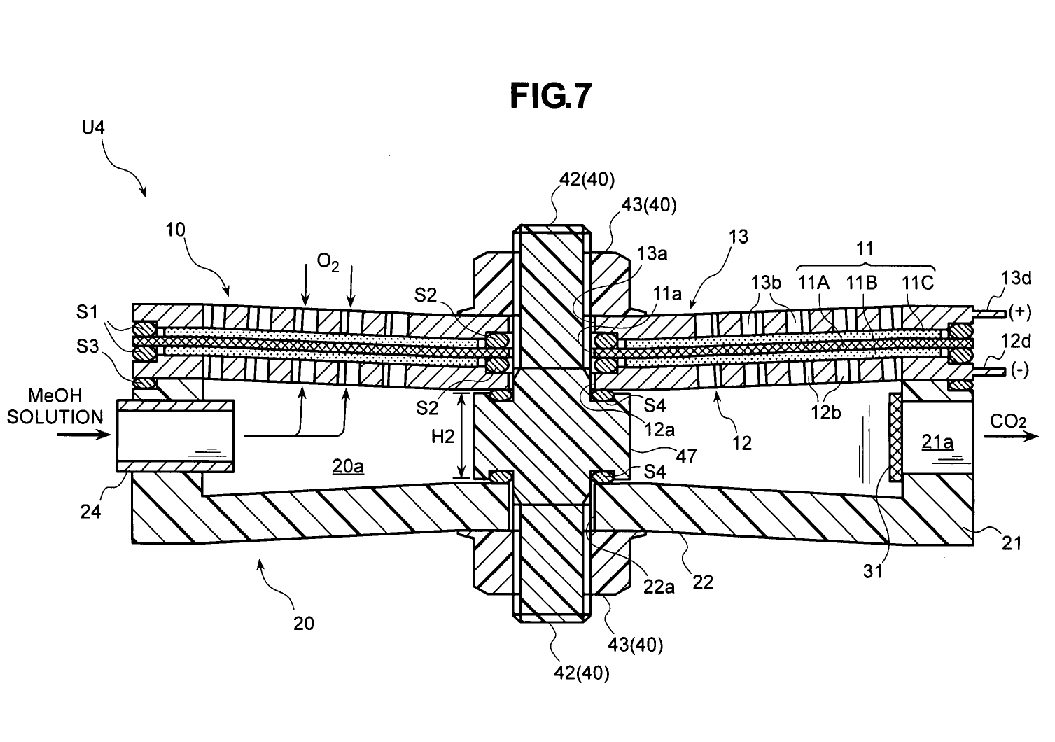

Next, explanation will be made about a DMFC unit according to a fourth embodiment, by referring to FIG. 7. This FIG. 7 is the cross-section view of the DMFC unit according to the fourth embodiment.

<<Structures of DMFC Unit>>

As is shown in FIG. 7, the DMFC unit U4 according to the fourth embodiment, comparing to the DMFC unit U1 (see FIG. 3) according to the first embodiment, comprises a spacer 47 in the place of the spacer 41. Height “H2” of the spacer 47 is determined to be lower than the height “H1” of the spacer 41.

And, screwing the nuts 43 onto the respective screw rods 42 to a predetermined degree brings the MEA module 10 into the condition of being bent into a side of the fuel chamber 20a. With this, within the MEA module 10, the holding force (i.e., contacting pressure) between the MEA 11 and the current collector plates 12 and 13 can be made larger than that of the first embodiment, and therefore the MEA 11 and the current collector plates 12 and 13 adhere to one another, preferably much more. However, in the fourth embodiment, the current collector plate 13 corresponds to “a current collector plate on an opposite side to the fuel tank 20”.

### FIFTH EMBODIMENT

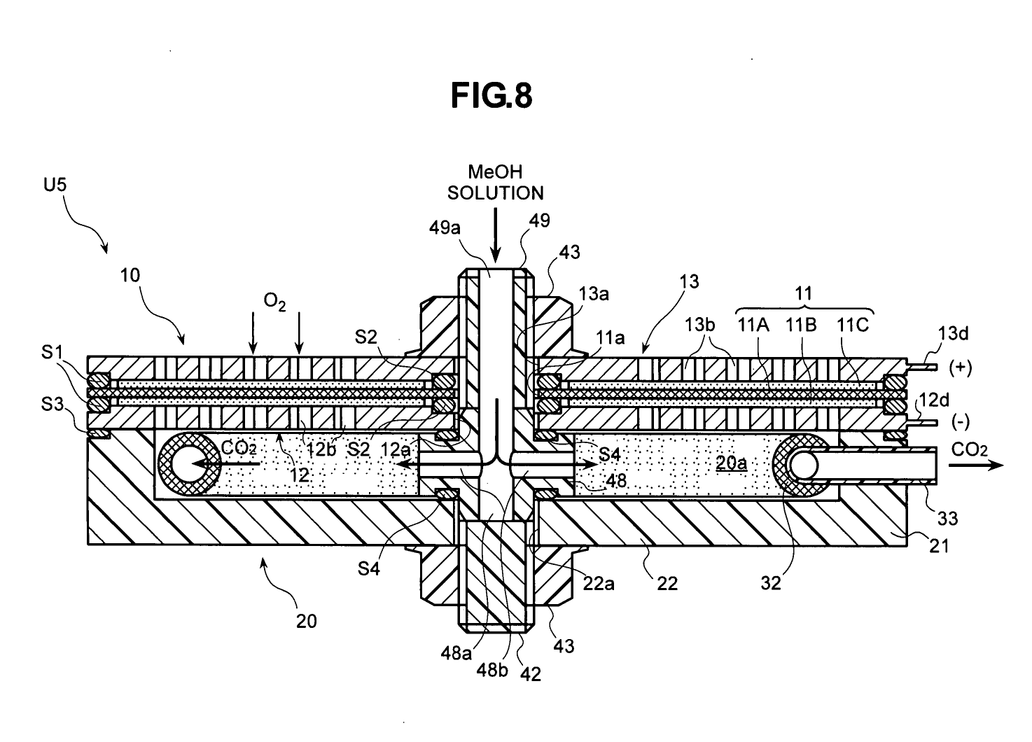

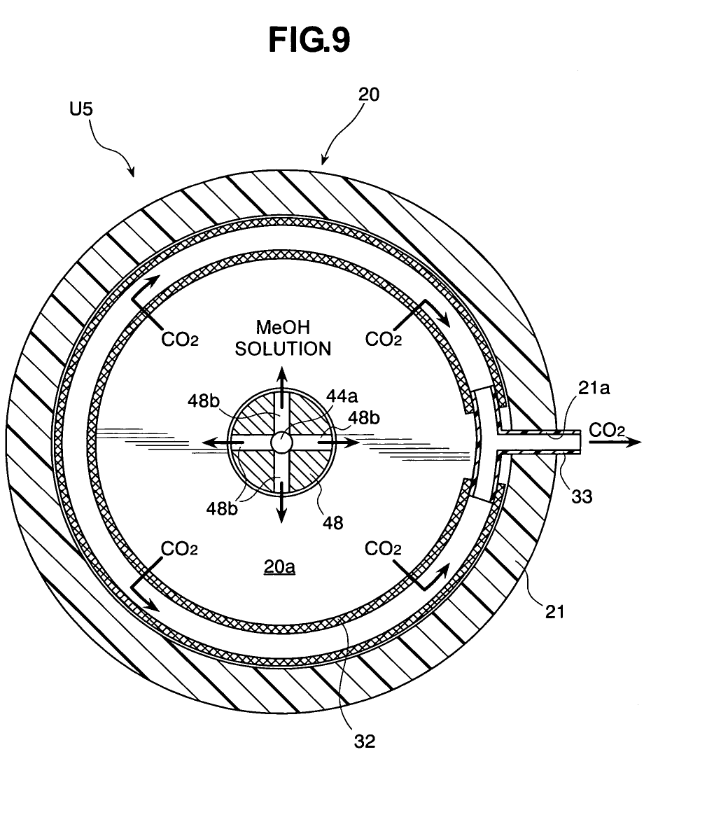

Next, explanation will be made about a DMFC unit according to a fifth embodiment, by referring to FIGS. 8 and 9. FIG. 8 is the cross-section view of the DMFC unit according to the fifth embodiment, and FIG. 9 is the plane cross-section of the DMFC unit according to the fifth embodiment.

<<Structures of DMFC Unit>>

As is shown in FIGS. 8 and 9, the DMFC unit U5 according to the fifth embodiment, comparing to the DMFC unit U1 (see FIG. 3) according to the first embodiment, is characterized by comprising a carbon-dioxide permeable tube 32 and a spacer 48 (i.e., liquid-fuel flow channel members), and a screw rod 49 (i.e., a liquid-fuel flow channel member).

<Carbon-Dioxide Permeable Tube>

The carbon-dioxide permeable tube 32 is that obtained by forming the carbon-dioxide permeable membrane 31 into a tube-like shape. The carbon-dioxide permeable tube 32, as is shown in FIG. 9, is circular in the plane view thereof, and is disposed within the fuel chamber 20a. Both ends of the carbon-dioxide permeable tube 32 are connected to a T-shaped joint 33, other one of which is inserted into connecting hole 21a. And a hollow portion of the carbon-dioxide permeable tube 32 is connected into an outside of the DMFC unit U5 through a hollow portion of the T-shaped joint 33.

Accordingly, the carbon dioxide generated in the anode passes through the peripheral wall of the carbon-dioxide permeable tube 32, to enter into the hollow portion thereof, and after passing through an inside of the carbon-dioxide permeable tube 32 and an inside of the joint 33, it is discharged into an outside of the DMFC unit U5. Thus, the carbon dioxide will not flouting for a long time within the fuel chamber 20a, but discharged outside quickly. With this, it is possible to supply the methanol solution to the anode 11B, effectively.

<Spacer>

The spacer 48 has a first liquid-fuel flow passage or channel 48a in the axial direction (i.e., in direction of the normal line of the MEA 11) and four (4) second liquid-fuel flow passages or channels 48b in the radial direction for connecting between the first liquid-fuel flow passage 48a and the fuel chamber 20a. The four (4) second liquid-fuel flow channels 48b are formed radially, at a distance of 90 degree in the peripheral direction thereof (see FIG. 9). However, the number of the second liquid-fuel flow channel 48b should not be restricted only to that.

<Screw Rod>

The screw rod 49 has a first liquid-fuel flow channel 49a in the axial direction thereof (i.e., in direction of the normal line of the MEA 11). And, the first liquid-fuel flow channel 49a of the screw rod 49 is connected with the first liquid-fuel flow channel 48a of the spacer 48.

Accordingly, when the methanol solution is supplied into the first liquid-fuel flow channel 49a of the screw rod 49, the methanol solution passes through the first liquid-fuel flow channel 49a, the first liquid-fuel flow channel 48a and the second liquid-fuel flow channels 48b, to be supplied into the fuel chamber 20a. Therefore, there is no need of provision of special piping, such as, the fuel intake pipe 24 (see FIG. 2), in the fuel tank 20, and then the DMFC unit U5 can be made small in sizes thereof. Also, since the four (4) pieces of the second liquid-fuel flow channels 48b are disposed in the radial manner, therefore the methanol solution can be supplied into the fuel chamber 20a, equally or uniformly.

### SIXTH EMBODIMENT

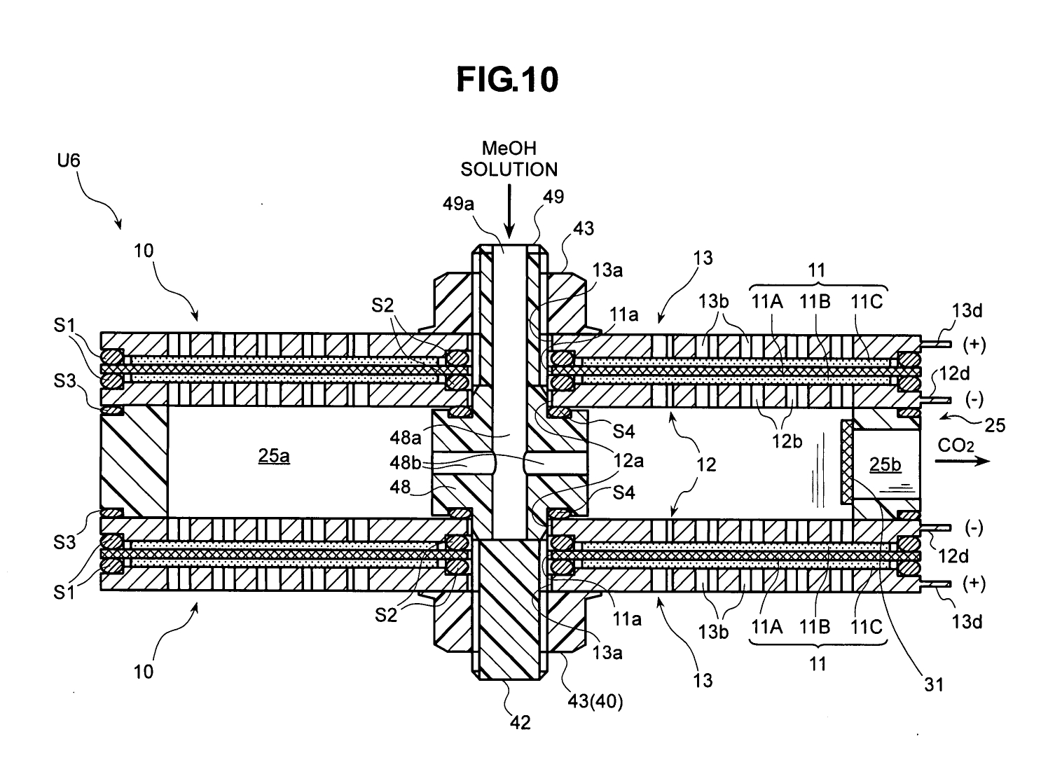

Next, explanation will be made about a DMFC unit U6 according to a sixth embodiment, by referring to FIG. 10. This FIG. 10 is the cross-section view of the DMFC unit according to the sixth embodiment.

<<Structures of DMFC Unit>>

As is shown in FIG. 10, the DMFC unit U6 according to the sixth embodiment, comparing to the DMFC unit U1 (see FIG. 3) according to the first embodiment, is characterized by comprising other MEA module 10 including a fuel tank 25 and other one MEA 11 (i.e., other membrane electrode assembly). The DMFC unit U6 comprises the spacer 48 and the screw rod 49 according to a seventh embodiment.

<Fuel Tank>

The fuel tank 25 has a ring-like shape on the plane view thereof, and a hollow portion thereof defines the fuel chamber 25a (i.e., a liquid-fuel storage space). In the peripheral wall of the fuel tank 25 is formed a connecting hole 25a, and a carbon-dioxide permeable film or membrane 31 is fixedly attached, thereby covering over it.

<MEA Module>

Two (2) pieces of the MEA modules 10 and 10 are opposite to each other on the side of the anodes 11B, putting the fuel tank 25 between them. Thus, the MEA modules 10 and 10 (or the MEAs 11 and 11) share the fuel tank 25 in common, and the methanol solution within the fuel chamber 25a is supplied into the each anode 11B of the MEAs 11 and 11 provided on both sides. Further, the condition of putting the fuel chamber 25 between the MEA modules 10 and 10 is maintained with an aid of the nuts 43 screwed onto the screw rod 49, and also the nuts 43 screwed onto the screw rod 42.

With such the DMFC unit U6, providing the MEA 11 by two (2) pieces thereof enables to double an output thereof, approximately. And, putting the fuel tank 25 between the MEA modules 10 and 10, thereby to share the fuel tank 25 in common, enables to thin thickness of the DMFC unit U6, as a whole, comparing to the case where each MEA module has the fuel tank.

### SEVENTH EMBODIMENT

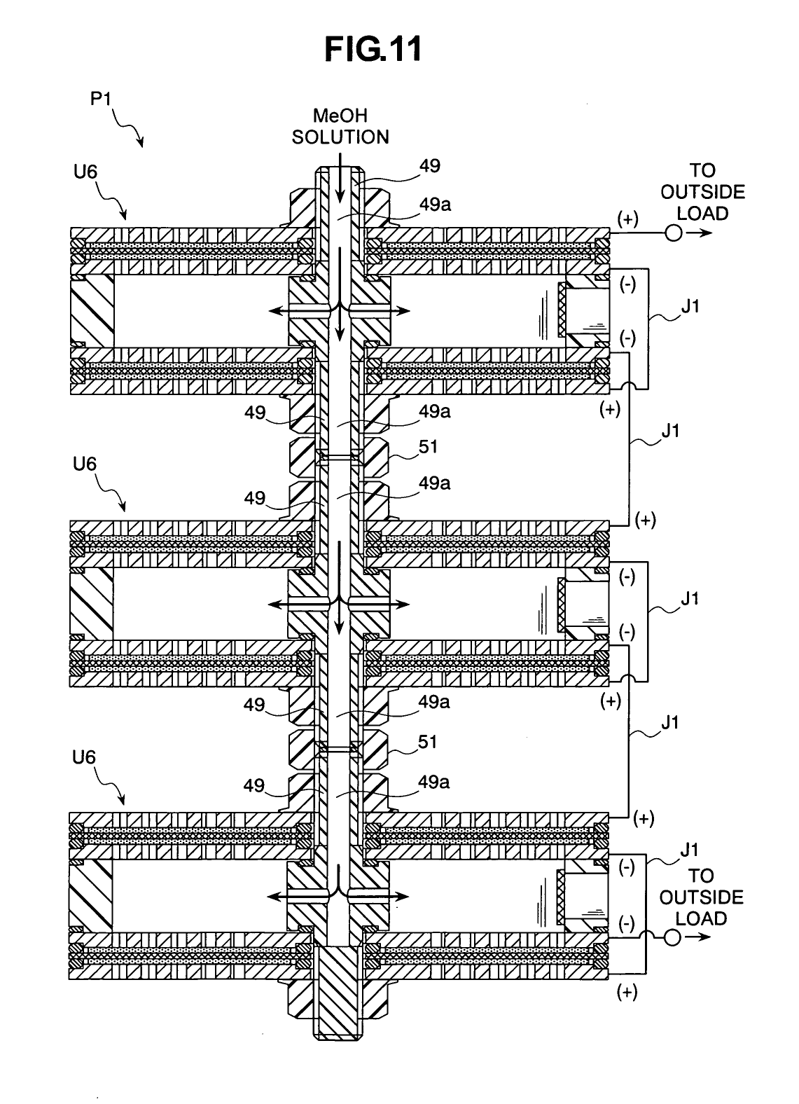

Next, explanation will be made about a DMFC pack P1 (i.e., a DMFC unit assembly) according to a seventh embodiment, by referring to FIG. 11. This FIG. 11 is the cross-section view of the DMFC pack according to the seventh embodiment.

<<Structures of DMFC Pack>>

As is shown in FIG. 11, the DMFC pack P1 comprises three (3) pieces of the DMFC units U6 according to the sixth embodiment. And, those three (3) pieces of the DMFC units U6 are connected to one another, by means of connecting nuts 51 and 52 screwed onto the screw rods 49, in three (3) stages.

In the DMFC units U6 neighboring to each other up and down, the first liquid-fuel flow channels of the screw rods 49 and 49 are connected or communicated with each other. However, for connecting them in this manner, the screw rod 42 on the lower side of the spacer shown in FIG. 10 is changed, appropriately, into the screw rod 49 having the first liquid-fuel flow channel therein.

Accordingly, when the methanol solution is supplied into the first liquid-fuel flow channel 49a of the DMFC unit U6, which is positioned at the uppermost stage in FIG. 11, then the methanol solution is also supplied into the DMFC units U6 at the second and third stages.

Also, the three (3) pieces of the DMFC units U6 are connected in series through a plural number of jumper lines J1; thereby an output of the DMFC pack P1 is increased to be high.

### EIGHTH EMBODIMENT

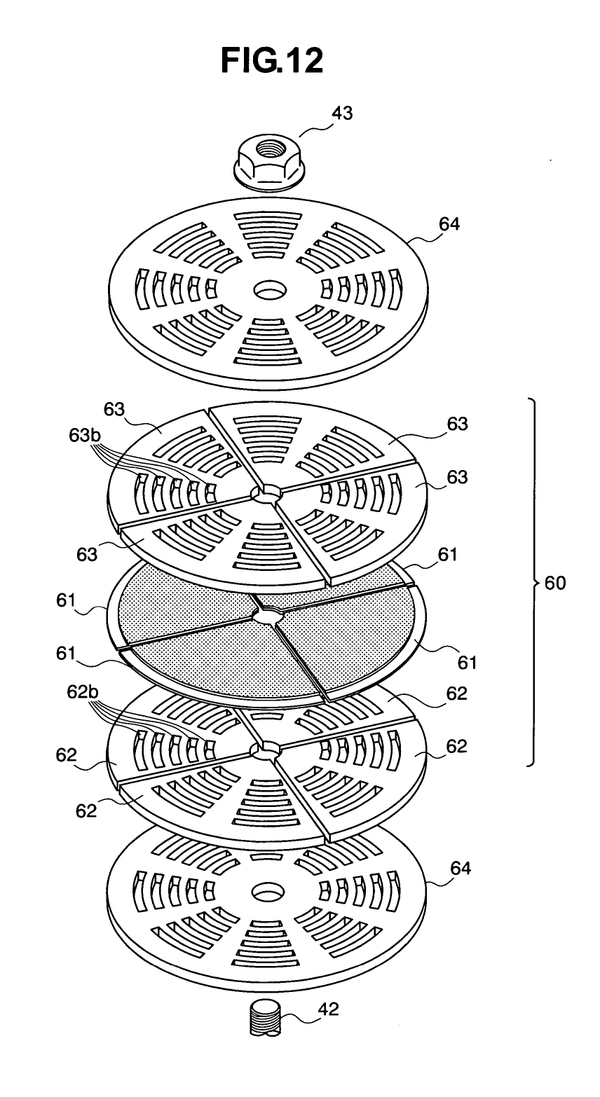

Next, explanation will be made about a DMFC unit according to an eighth embodiment, by referring to FIG. 12. This FIG. 12 is a perspective view exploding principal portions of the DMFC unit according to the eighth embodiment.

<<Structures of DMFC Unit>>

As is shown in FIG. 12, the DMFC unit according to the eighth embodiment, comparing to the DMFC unit according to the first embodiment (see FIG. 4), comprises a MEA module 60 and a pair of holding plates 64 and 64, mainly.

<MEA Module>

The MEA module 60 comprises four (4) pieces of MEAs, each being in a quarter-circle shape (i.e., sector-like), four (4) pieces of current collector plates 62 (i.e., anode current collector plates), and four (4) pieces of current collector plates 63 (i.e., cathode current collector plates), mainly.

Those four (4) pieces of MEAs are disposed in directions on the same surface, and an outer edge of an area where the four (4) pieces of MEAs are disposed defines a circle. And, in each the MEA 61 is disposed a current collector plate 62 on a side of the anode (e.g., the lower side in FIG. 12), and a current collector plate 63 on a side of the cathode (e.g., the upper side in FIG. 12), respectively. Also, in each of the current collector plates 62 is formed a plural number of fuel channel openings 62b, while in the current collector plate 63 a plural number of airflow openings 63b.

<Holding Plate>

The pair of the holding plates 64 and 64, each being disk-like, are disposed on both outer sides, i.e., up and down, of the MEA module 60.

And, the holding plates 64 and 64 and the MEA module 60 are disposed on the same axial line, wherein the screw rod 42 penetrates through those. Next, screwing the nut 43 onto the screw rod 42 bring the pair of holding plates 64 and 64 to hold the MEA module 60, putting it between them. Namely, the pair of the holding plates 64 and 64 are so constructed that they hold the four (4) pieces of the current collector plates 63 divided into peripheral direction thereof, the MEAs 61 and the current collector plate 62, together with, as a whole.

Accordingly, with the DMFC unit having such structures, i.e., comprising the four (4) pieces of the MAEs 61 therein enables to increase an output thereof. However, a method of electrically connecting the respective MEAs 61 may be in series, or alternatively in parallel with. Also, herein given the case where four (4) pieces of the current collector plates 62 and four (4) pieces of the current collector plates 63 are provided corresponding to the four (4) pieces of the MEAs 61, however in case where the four (4) pieces of the MEAs 61 are connected in parallel with, the MEA module 60 may be put between them, by using the current collector plates 12 and 13 (see FIG. 4) in the place of the current collector plates 62 and 63. In this instance, the holding plate 64 and 64 are unnecessary.

### NINTH EMBODIMENT

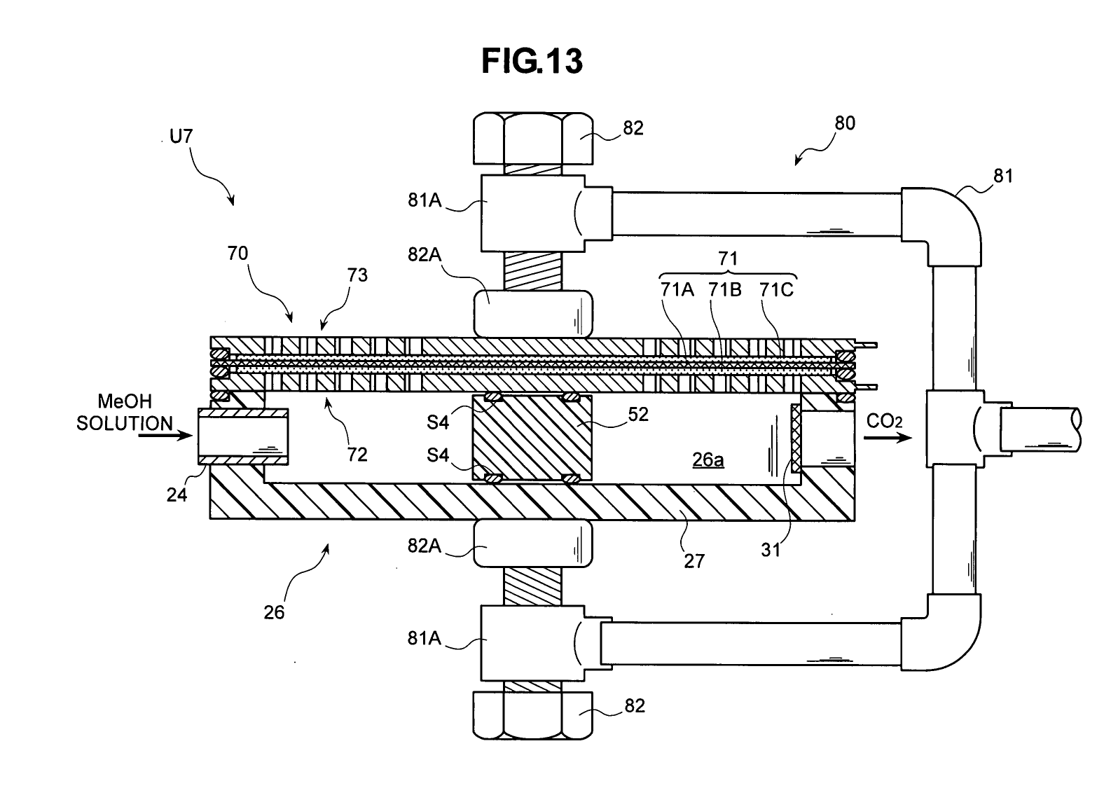

Next, explanation will be made about a DMFC unit U7 according to a ninth embodiment, by referring to FIG. 13. This FIG. 13 is the cross-section view of the DMFC unit according to the ninth embodiment.

<<Structures of DMFC Unit>>

As is shown in FIG. 13, the DMFC unit according to the ninth embodiment, comparing to the DMFC unit U1 according to the first embodiment, is characterized by comprising a MEA module 60 and a holding means 80, mainly.

<MEA Module>

The MEA module 70 comprises a MEA 71, and the current collector plates 72 and 73, and is constructed by holding the MEA 71 between the current collector plates 72 and 73. The MEA 71 comprises an electrolyte membrane 71A, an anode 71B and a cathode 71C, and is constructed by holding the electrolyte membrane 71A between the anode 71B and the cathode 71C.

Herein, the MEA 71 and the current collector plates 72 and 73 have no through-hole therein, and an effective area of the electrolyte membrane 71A of the MEA 71 is larger than the effective area of the electrolyte membrane 11A according to the first embodiment.

The holding member 80 comprises a holding arm 81, which is divided into two (2) at the tip side thereof (the left-hand side in FIG. 13), and bolts 82 and 82 (i.e., axial members). Each of the tip portions 81A (i.e., a screw portion) of the holding arm 81 is cylinder-like in the shape, and a female thread groove is formed on an interior peripheral surface thereof, onto which the bolt 82 is screwed. The axial line of the bolt 82 and the normal line of the MEA 71 are coincide with each other in the direction thereof, and an abutting portion 82A is provided on each the bolt 82, on a side of the MEA module 70, for the purpose of stably holding therebetween. And, when rotating the bolts 82 or 82 into a predetermined direction, the distance between the abutting portions 82A and 82A comes to be narrow, wherein the abutting portion 82A in the upper side of FIG. 13 touches on the current collector plate 73, and the abutting portion 82A in the lower side of FIG. 13 touches on the bottom wall 27 of the fuel tank 26, respectively; as a result thereof, the current collector plates 72 and 73 hold the MEA 71 between them.

Also, the spacer 52 is disposed within the fuel tank 26, on the axial line of the bolt 82, and thereby maintaining the space of the fuel tank 26a at a predetermined position, in direction of the depth thereof.

Accordingly, with such the DMFC unit U7, the effective area of the electrolyte membrane 71A can be enlarged, thereby enabling to increase the output thereof.

In the above, though the explanation was made about one example of each the preferable embodiment, according to the present invention, however the present invention should not be limited to the respective embodiments mentioned above, and therefore each of the embodiments may be combined with, or may be changed, appropriately, within the scope of the invention, but not departing from the gist thereof.

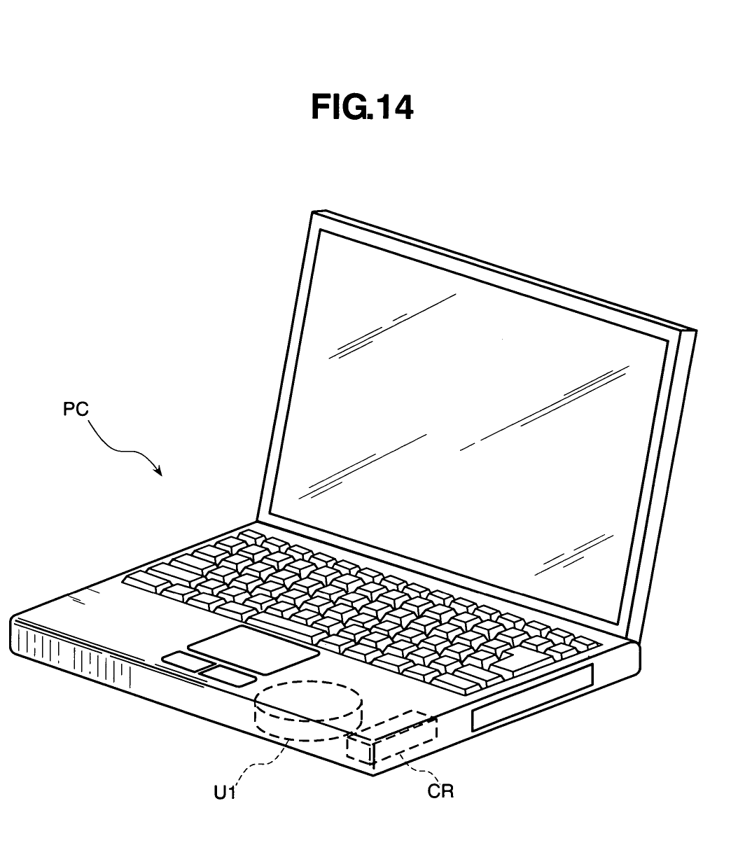

In the first embodiment mentioned above, the explanation was made about the case where the DMFC unit U1 is the outer electric power source, however other than that, for example, it may be a case, as is shown in FIG. 14, where the DMFC unit U1 is installed into the note-type personal computer PC together with a fuel cartridge CR.

In the first embodiment mentioned above, the explanation was made that the MEA 11, being disk-like in the outer shape, is held between the current collector plates 12 and 12, each being disk-like in the outer shape, however the shape of the MEA and the current collector plates should not limited only to this, but for example, it may be rectangular in the plane view thereof.

In the second embodiment mentioned above, though the explanation was given that the holding plate 14 is provided outside the current collector plate 13A of the cathode 11C, however the holding plate 14 may be provided outside the current collector plate 12A of the anode 11B, in the structures thereof. Also, the holding plate 14 may be provided outside, at least one of the current collector plates 12A and 13A, in the structures thereof.

With the third embodiment mentioned above comprising the tension coil spring 45 therein, it was explained that the MEA module 10 is held between, with using the tension force (i.e., the suppressing force), however the spring should not be restricted only to that, it may be a compression coil spring, a disk spring, etc.

In the fifth embodiment mentioned above, it was explained that the carbon-dioxide permeable tube 32 is disposed to be one (1) layer in the plane view thereof, however the method of disposing the carbon-dioxide permeable tube 32 should not limited only to this; for example, the carbon-dioxide permeable tube 32 may be disposed to be multi-layers.

In the seventh embodiment mentioned above, the explanation was made only about the case where the three (3) DMFC units U6 are constructed or piled up in three (3) stages thereof, but the number of the stages should not be limited to this, but it may be changed appropriately and freely.

Also, though the explanation was made on the case where the DMFC units U6 connected in three (3) stages are connected in series through the jumper lines J1, it should not be limited to this in the connecting method; for example, they may be connected in parallel with. Further, with the connection method therebetween, two (2) MEAs 11 and 11 among one (1) piece of the DMFC unit U6 may be connected in series or alternatively in parallel with.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A fuel cell unit for generating electricity through supply of a liquid fuel therein, comprising:
a membrane electrode assembly;
a pair of current collector plates for said membrane electrode assembly;
a fuel tank having a liquid-fuel storage space for storing the liquid fuel therein; and
a holding means for holding said current collector plates therebetween, within an area for disposing said membrane electrode assembly.

2. The fuel cell unit, as described in the claim 1, wherein said holding means holds said current collector plates at around a central position of said area for disposing.

3. The fuel cell unit, as described in the claim 1, wherein an outer edge of said area for disposing is circular-like.

4. The fuel cell unit, as described in the claim 1, further comprises a holding plate in an outside of at least one of said pair of current collector plates.

5. The fuel cell unit, as described in the claim 4, wherein said membrane electrode assemblies are provided in a plural number thereof, and said plural number of membrane electrode assemblies are disposed on a surface in direction thereof.

6. A fuel cell unit for generating electricity through supply of a liquid fuel therein, comprising:
a plural number of membrane electrode assemblies;
a plural number of current collector plates corresponding to said plural number of membrane electrode assemblies;
a fuel tank having a liquid-fuel storage space for storing the liquid fuel therein; and
a pair of holding plates for holding said plural number of membrane electrode assemblies and said plural number of current collector plates, collectively, putting them therebetween from an outside, wherein said plural number of membrane electrode assemblies are disposed on a surface in direction thereof.

7. The fuel cell unit, as described in the claim 1, wherein said holding means comprises:
an axial member, being disposed in direction of a normal line of said membrane electrode assembly, and having thread groove therein; and
a screw member to be screwed into said thread groove.

8. The fuel cell unit, as described in the claim 1, wherein said holding means comprises a spring, thereby holding them with using suppression force of said spring.

9. The fuel cell unit, as described in the claim 1, wherein a side of said fuel tank is opened on a side facing to said membrane electrode assembly;
said holding means puts the current collector plate on an opposite side to said fuel tank; and
said membrane electrode assembly is bent into a side of said fuel tank.

10. The fuel cell unit, as described in the claim 1, wherein a carbon-dioxide permeable membrane is provided in said holding means for passing through carbon dioxide generating in an anode to be discharged into an outside.

11. The fuel cell unit, as described in the claim 10, wherein:
said carbon-dioxide permeable membrane is a tube-like carbon-dioxide permeable membrane tube; and
said carbon-dioxide permeable membrane tube is disposed within said liquid-fuel storage space, wherein the carbon dioxide is discharged into an outside, passing through within said carbon-dioxide permeable membrane tube.

12. The fuel cell unit, as described in the claim 1, further comprising other membrane electrode assembly than said membrane electrode assembly,
wherein said membrane electrode assembly and said other membrane electrode assembly share said fuel tank, in common, putting it between them.

13. The fuel cell unit, as described in the claim 1, further comprising: a first liquid-fuel flow channel in direction of said normal line, and a second liquid-fuel flow channel for connecting between said first liquid-fuel flow channel and said liquid-fuel storage space.

14. The fuel cell unit, as described in the claim 13, wherein said liquid-fuel flow channel member has said second liquid-fuel flow channels in plural number thereof, and said second liquid-fuel flow channels are disposed, radially.

15. A fuel cell unit assembly, comprising:
fuel cell units as described in the claim 13, in plural number thereof, wherein:
said plural number of fuel cell units are disposed in a plural number of stages thereof, and
said first liquid-fuel flow channel of each of said fuel cell units is connected with each other.

16. An electronic apparatus installing a fuel cell unit described in the claim 1 therein.
